(19) United States
(12) Patent Application Publication
(10) Pub. No.: US 2026/0318338 A1
(43) Pub. Date: Oct. 15, 2026

(54) SYSTEMS AND METHODS FOR SECURING A MECHANICAL DEVICE TO A STRUCTURE

(71) Applicants: David F. Nagle, Christiansted, VI (US); Parker F. Nagle, Christiansted, VI (US)

(72) Inventors: David F. Nagle, Christiansted, VI (US); Parker F. Nagle, Christiansted, VI (US)

(21) Appl. No.: 19/644,807

(22) Filed: Apr. 10, 2026

Related U.S. Application Data
(60) Provisional application No. 63/787,116, filed on Apr. 11, 2025.

(51) Int. Cl. F16B 7/04; B63H 9/10

(52) U.S. Cl. CPC F16B 7/04; B63H 9/10

(57) ABSTRACT

A coupling system includes a first clamp member and a second clamp member. The first clamp member includes a first end, a second end, and a body extending therebetween. The first end is formed with a coupling mechanism. The second end formed with at least one fastener opening extending therethrough. The second clamp member includes a first end, a second end, and a body extending therebetween. The first end is formed with a coupling mechanism. The second end is formed with at least one fastener opening therethrough. The second clamp member first end is configured to engage the first clamp member first end to rotatably couple the first clamp member with the second clamp member. The second clamp member second end is configured to couple to the first clamp member second end such that the coupling member can be securely coupled to the structure without damaging the structure.

### CROSS-REFERENCE TO RELATED APPLICATIONS

This application claims priority to, and is a non-provisional application of U.S. Provisional Application 63/787,116 entitled Systems and Methods for Securing a Mechanical Device to a Tubular Structure filed Apr. 11, 2025, which is hereby incorporated by reference in its entirety.

### FIELD OF THE INVENTION

The present disclosure relates to a coupling system used to fasten mechanical devices to a structure and, more particularly, to systems and methods for coupling a clamping system including at least one mechanical device to a structure, such as but not limited to a tubular structure.

### BACKGROUND

Watercraft sports have become increasingly popular particularly in areas where a constant or consistent wind is blowing. One of the more popular types of wind driven watercraft is a mast and sail type of craft in which a mast is mounted to the boat to support one or more sails that can be selectively positioned around the mast to take full advantage of the wind. Modern boating has seen dramatic developments in technologies which reduce the drudgery of handling sails that was common in the past several decades. In particular, sailboats that enable allow easy furling and reefing of sails have proliferated, such that at least some sailboats allow a single person to set, reef, furl, and secure sails with a minimum of effort.

At least some known sailboats, include a hull, a fixed or rotating mast, a rudder, and a mainsail that enables the sailboat to maneuver using wind power. A sailor controls the sails using ropes and/or lines and a direction of the boat using a rudder. Within at least some boat designs, a horizontal boom extends from the mast along the foot (bottom) of the mainsail, and a halyard extends from the head (top) of the sail through the top of the mast and down to the deck of the boat. On at least some boat deigns, the halyard enables the mainsail to be selectively raised and lowered to enable the sailor to control an amount of sail exposed to the wind. The sail can be maintained in tension using a downhaul line that has one end coupled to the tack (i.e., the front bottom corner) of a sail, and its other end run through a fitting, such as a cleat or block, attached to the boom or mast or anchored to the boat.

Over time, depending on the use of the sailboat, the tension on the block secured to the deck of the boat may cause the block to pull away from the top of the deck. To relieve the tension on the block, sailors often couple an additional cleat to the mast for use in securing the halyard line. Such additional cleats are commonly coupled to the mast with fasteners that are drilled or threaded into the metallic mast at a location that is convenient for the sailor. Although such cleats relive the tension induced to the block and to the boat deck, drilling into the mast creates a weak spot that increases the likelihood that the mast may corrode and/or fail at that cleat location. Often, depending on the extent of the damage to the mast, the mast must be replaced in a time-consuming and costly process.

Accordingly, it is desirable to have systems and methods that can be used to secure a mechanical device, including a mechanical device, to a structure in a manner that is efficient, secure, and easily duplicatable without causing damage to the underlying structure.

### BRIEF SUMMARY

In one aspect, a coupling system for use with a structure is provided. The coupling system includes a first clamp member and a second clamp member. The first clamp member includes a first end, a second end, and a body extending therebetween. The first end is formed with a coupling mechanism. The second end formed with at least one fastener opening extending therethrough. The second clamp member includes a first end, a second end, and a body extending therebetween. The first end is formed with a coupling mechanism. The second end is formed with at least one fastener opening therethrough. The second clamp member first end is configured to engage the first clamp member first end to rotatably couple the first clamp member with the second clamp member. The second clamp member second end is configured to couple to the first clamp member second end such that the coupling member can be securely coupled to the structure without damaging the structure, and such that coupling system tightly circumscribes the structure.

In another aspect, a clamping system for coupling a mechanical device to a structure is provided. The clamping system includes a pair of substantially identical clamping members that each include a first end that includes at least one hinge member, and a second end that includes at least one fastener opening extending therethrough. The clamping members each include an inner surface that is shaped to substantially mirror an exterior surface of the structure, and a radially opposite outer surface that extends generally continuously from the first end to the second end. At least one of the clamping members includes a flat formed on an outer surface of that clamping member. The flat is sized and shaped to enable the mechanical device to couple to the clamping system without damaging the structure.

In a further aspect, a method of securing a mechanical device to a structure without damaging the structure is provided. The method includes providing a clamp system including a pair of clamp members that are substantially identical, and engaging a first end of a first of the clamp members with a first end of the second of the clamp members, such that the first ends of each of the clamp members are interlocked. The method also includes rotating at least one of the first clamp member and the second clamp member to an open position, positioning the clamp system near the structure and rotating the clamp members to a closed position, and inserting at least one fastener through a portion of the first and second clamp members to securely couple the first clamp member to the second clamp member, and to securely couple the clamp assembly about the structure, such that an inner surface of the clamp members tightly circumscribes an outer surface of the structure. In addition, the method includes coupling the mechanical device to the coupling system and to the structure without damaging the structure.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an exemplary embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a perspective view of an exemplary watercraft including an exemplary coupling system in accordance with one embodiment of the invention.

FIG. 2 is an enlarged isometric front view of the coupling system shown in FIG. 1 and taken along area 2.

FIG. 3 is a perspective view of a portion of the coupling system shown in FIG. 2 and in an open position.

FIG. 4 is a perspective view of a portion of the coupling system shown in FIGS. 2 and 3.

FIG. 5 is a flow chart of an exemplary method of attaching a coupling system to an annular structure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The present embodiments may relate to, inter alia, systems and methods for securely attaching a coupling system to a structure in a manner that facilitates eliminating the potential for damage to the underlying structure. In one embodiment, the systems and methods described herein include a coupling system that enables at least one mechanical coupler to be removably coupled to any structure in a manner such that the coupling system circumscribes the structure without causing any damage to the underlying structure.

In one embodiment, the coupling system described herein includes an annular clamp that includes a pair of arcuate clamp members that are hingedly coupled together in a clam-shell configuration along a first side of each clamp member and that are removably coupled together along a second side of each clamp member. Moreover, in the exemplary embodiment, the pair of clamp members are substantially identical and the clam-shell configuration substantially “murphy-proofs” the installation of the coupling system. In an alternative embodiment, the clamp members are fixedly secured together along either the first or second side of each clamp member.

Although specific features of various embodiments may be shown in some drawings and not in others, this is for convenience only. In accordance with the principles of the systems and methods described herein, any feature of a drawing may be referenced or claimed in combination with any feature of any other drawing.

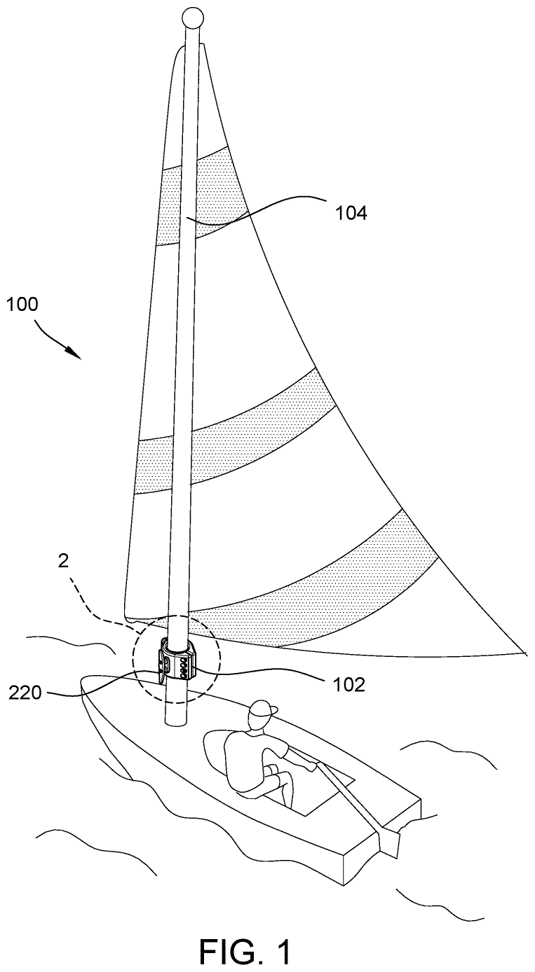

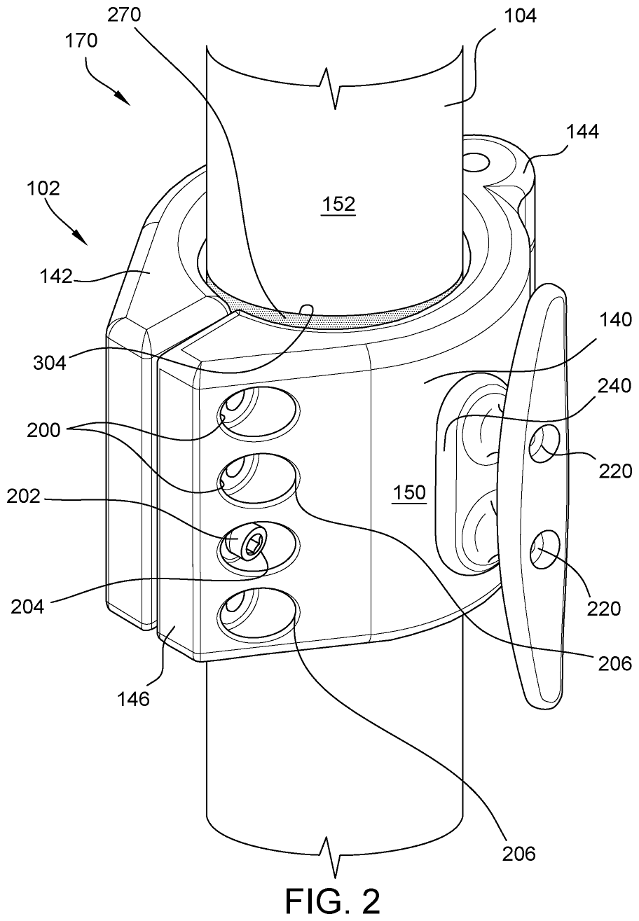

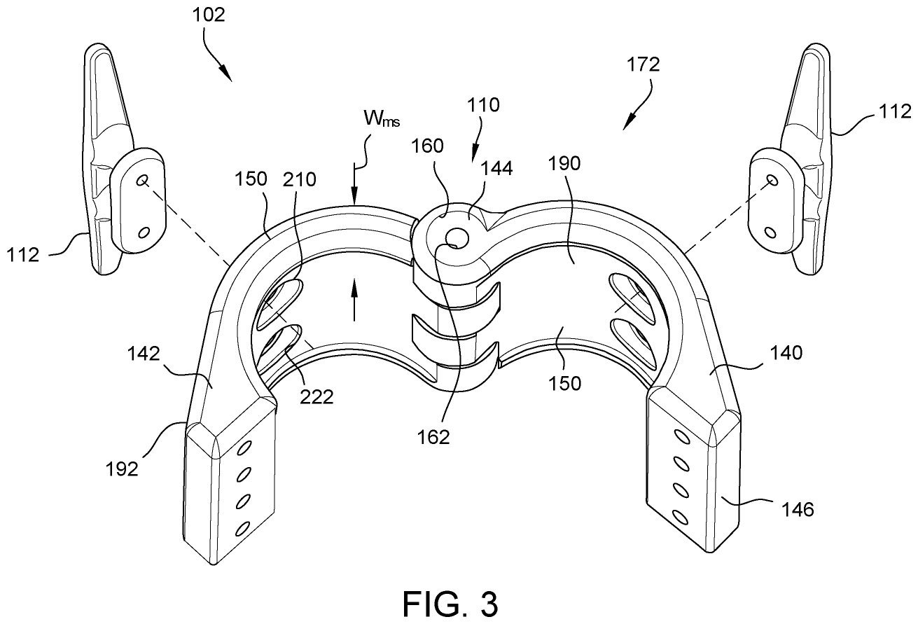

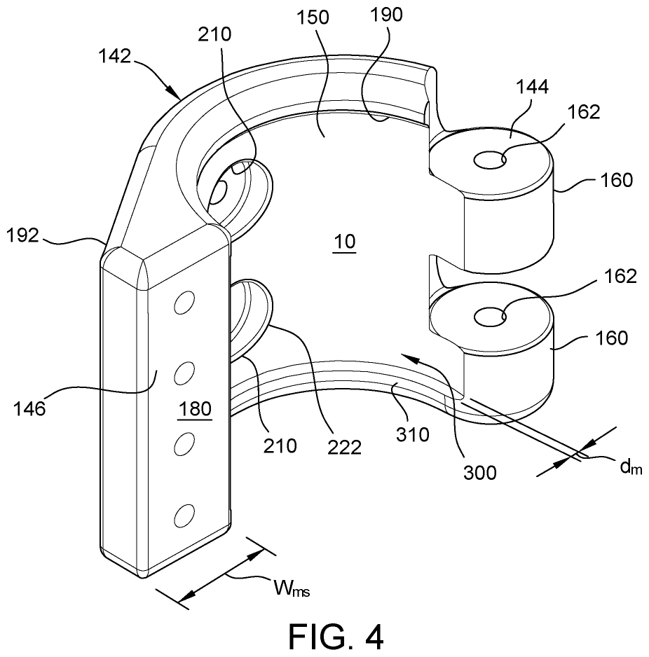

FIG. 1 is a perspective view of an exemplary watercraft 100 including an exemplary coupling system 102 in accordance with one embodiment of the invention. FIG. 2 is an isometric front view of the coupling system 102 shown in FIG. 1 and secured to a structure 104. FIG. 3 is a perspective view of a portion of the coupling system 102 shown in FIG. 2 in an open position 110, and oriented to enable a pair of cleats 112 to engage the coupling system 102. FIG. 4 is a perspective view of a portion of the coupling system 102.

In the exemplary embodiment, the coupling system 102 is secured in position within the watercraft 100. More specifically, in the exemplary embodiment, the structure 104 in the watercraft 100 is a mast having a circular cross-sectional profile. In alternative embodiments, the coupling system 102 may be used with any other support structure and is not limited to only being used with a structure having a circular cross-sectional profile. For example, in some embodiments, the coupling system 102 may be used with a structure having a substantially square cross-sectional area. In other alternative embodiments, the coupling system 102 may be used with a structure having any other cross-sectional profile, such as, but not limited to a triangular cross-sectional profile, a square cross-sectional profile, a rectangular cross-sectional profile, and/or a hexagonal cross-sectional profile. As described herein, the coupling system 102 may be sized for use with any structure having a cross-sectional profile that is sized to enable the coupling system 102 to substantially circumscribe the structure when the coupling system 102 is fully secured to the structure.

It should also be noted that the coupling system 102 described herein is not limited to only being used with a marine application and/or with a watercraft 100. For example, in alternative embodiments, the coupling system 102 may be used with any non-marine application, such as, but not limited to applications that use tie-down attachments such as, but not limited to aviation systems, oil and gas systems, food and beverage systems, storm damage prevention systems, large umbrella stands, flag poles, mobile home facility tie downs, vehicle transport trailers, cargo beds in trucks, and/or cargo vehicles, for example. In addition, the coupling system 102 described herein may be designed to secure any mechanical device, such as a cleat 112, to any structure, wherein the coupling system 102 circumscribes the structure without causing any damage to the underlying structure.

In the exemplary embodiment, the coupling system 102 is securely coupled to a watercraft 100, and more specifically, to a personal-sized, sailing dinghy, i.e., a single-handed sailing dinghy. Alternatively, the coupling system 102 may be used with any other watercraft 100 and/or any other vehicle, such as, but not limited to, a schooner, a sloop, a barque, a brig, a clipper, and/or any other marine watercraft that includes at least one attachment point that is typically secured to a portion of the watercraft, such as a deck, a railing, a dock frame, and/or a hull, for example, via a cleat, an eye hook, a peg, a jammer, a rope clutch, a block, and/or a shackle, for example. Moreover, it should be noted, that the coupling system 102 is not limited to only being used with a mast 104, but rather can be designed for use with any other structure, such as, but not limited to, a utility pole, a flag pole, a pipe, a hose, a beam, and/or a girder. In addition, although the coupling system 102 is described in association with a mast 104 that is commonly fabricated from, but is not limited to being fabricated from, a wood material, a composite material, an aluminum alloy material, a steel material, and/or a carbon fiber material, the coupling system 102 described herein may be designed for use with any structure fabricated from any other material, whether the underlying structure is solid or is hollow.

In the exemplary embodiment, the coupling system 102 is used to secure a cleat 112, i.e., a horn cleat. Although the coupling system 102 is shown as being used with a horn cleat 112, the system 102 is not limited to only being used with a horn cleat, and may be used with any other type of cleat, such as, but not limited to a Shaefer® cleat, a Ronstan® cleat, a jam cleat, a cam cleat, a rope clutch, a V cleat, a mooring cleat, and/or a deck cleat, for example. Moreover, the coupling system 102 may be used with any other type of mechanical device, such as, but not limited to, a hook, a loop, a peg, an eye bolt, a clevis, a hoist ring, and/or a flag support.

In the exemplary embodiment, the coupling system 102 includes a pair of clamp members 140 and 142. More specifically, in the exemplary embodiment, clamp members 140 and 142 are formed substantially identically and each includes a first end 144, an opposite second end 146, and a clamp body 150 extending therebetween. In an alternative embodiment, the clamp members 140 and 142 may be formed any differences, including distinct differences, that enable the coupling system 102 to function as described herein. In one embodiment, the clamp members 140 and 142 are fabricated from, but are not limited to only being fabricated from, a metallic material, a carbon graphite material, a plastic material, a bioplastic material, a fiberglass material, a silicon material, and/or a combination thereof. Moreover, in the exemplary embodiment, coupling system 102 is intended for use with a mast 104 having a substantially circular cross-sectional profile, and as such, clamp bodies 150 are each arcuate and are formed with a radius of curvature that substantially mirrors an exterior surface 152 of mast 104. In alternative embodiments, at least one clamp body 150 may be formed with a non-arcuate shape. In the exemplary embodiment, each clamp body 150 is formed with a shape that substantially mirrors the perimeter of the cross-sectional shape of the structure 104 to which the coupling system 102 is being secured to. In other words, clamp bodies 150 are shaped to enable clamp members 140 and 142 to substantially conform against the exterior surface 152 of the structure 104 when coupling system 102 is fully secured to the structure 104, as described in more detail below.

Each clamp first end 144, in the exemplary embodiment, is formed with a pair of annular hinge members 160 that each include an opening 162 extending therethrough. In the exemplary embodiment, hinge members 160 are each sized identically and each opening 162 is sized identically. Moreover, in the exemplary embodiment, the hinge members 160 on clamp member 140 are laterally offset from the hinge members 160 on clamp member 142. The lateral offset between the hinge members 160 on opposed clamp members 140 and 142 enables the hinge members 160 to interdigitate or interlock such that the hinge member openings 162 are substantially concentrically aligned laterally when the clamp members 140 and 142 are coupled together along their first ends 144. Accordingly, when a retaining pin (not shown) is inserted laterally through openings 162 when hinge members 160 are interlocked, the retaining pin securely couples the clamp first ends 144 together such that first clamp member 140 is securely coupled to the second clamp member 142 while also being rotatably coupled to the second clamp member 142. More specifically, the combination of the retaining pin and the annular hinge members 160 enables the first clamp member 140 to rotate relative to the second clamp member 142, and the second clamp member 142 to rotate relative to the first clamp member 140, from a closed position 170 (shown in FIG. 2) to an open position 172 (shown in FIG. 3).

In alternative embodiments, either clamp member 140 and/or 142 may be formed with more or less than two hinge members 160. Moreover, in other embodiments, the coupling system 102 may be designed such that when the clamp members 140 and 142 are securely coupled, only one of the clamp members 140 or 142 may rotate relative to the other clamp member 142 or 140. Furthermore, in other embodiments, the coupling system 102 may include other hinge types rather than an offset hinge, such as but not limited to a butt hinge. In addition, in other embodiments, clamp members 140 and/or 142 may be coupled together using any other coupling mechanism other than a hinged connection, such as, but not limited to, a mechanical fastener, a biased spring-like mechanism, a magnetic coupling, and/or any other coupling mechanism that enables the coupling system 102 to function as described herein.

Each clamp second end 146, in the exemplary embodiment, is formed with a mating surface 180 that is substantially smooth. More specifically, in the exemplary embodiment, each mating surface 180 is generally flat. In alternative embodiments, each mating surface 180 may be formed as a tapered surface, a textured surface, a nested joint surface, an interlocking surface, and/or any other surface that enables the coupling system 102 to function as described herein. In the exemplary embodiment, each mating surface 180 is rectangular. In alternative embodiments, each mating surface 180 may have any other non-rectangular shape.

In the exemplary embodiment, each mating surface 180 extends from a radially inner surface 190 to a radially outer surface 192 of each respective clamp member 140 and 142. Inner and outer surfaces 190 and 192, respectively, extend continuously from each clamp first end 144 to each clamp second end 146. Alternatively, in other embodiments, surface 190 and/or 192 may be segmented and/or broken into multiple surface pieces. In the exemplary embodiment, each clamp second end 146 is flared outwardly, such that a width Wₘₛ of each mating surface 180 is wider than a width W_{bp} of each clamp 150. In alternative embodiments, either mating surface 180 may have the same width Wₘₛ or a smaller width Wₘₛ than the width W_{bp} of either clamp 150.

A plurality of fastener openings 200 extend through the flared portion of each clamp second end 146 and through mating surface 180. More specifically, in the exemplary embodiment, coupling system 102 includes four fastener openings 200. Alternatively, coupling system 102 may include more or less than four fastener openings 200. For example, in alternative embodiments, coupling system 102 does not include any fastener openings 200 and instead uses any outer coupling mechanism that enables coupling system 102 to function as described herein. In the exemplary embodiment, openings 200 are identical and each is circular. Alternatively, openings 200 may be sized differently and/or shaped differently. Moreover, in the exemplary embodiment, each fastener opening 200 is recessed within the radial outer surface 192 of each clamp member 140 and 142. Accordingly, when a fastener 202 is fully inserted through a respective opening 200 to secure the clamp second ends 146 together, i.e., secure clamp member 140 to clamp member 142, each end 204 (only one end shown in FIG. 2) of each fastener 202, and an associated retaining device, i. e, a nut, for example, do not extend outwardly beyond the edge 206 defining each opening 200 within clamp outer surface 192. In one embodiment, coupling system 102 includes defined flats in the clamp member 140 that facilitate retaining a nut or fastener member such that a tool is not necessary to secure clamp member 140 to clamp member 142.

In the exemplary embodiment, openings 200 are substantially centered within mating surface 180 and are concentrically aligned laterally within mating surface 180. Moreover, in the exemplary embodiment, openings 200 are spaced substantially evenly laterally across mating surface 180. Alternatively, openings 200 may be spaced differently across mating surface 180 and/or may be arranged in any other orientation relative to mating surface 180, provided the openings in clamp member 140 are substantially concentrically aligned with respect to the openings in clamp member 142 when the coupling system 102 is in the closed position 170.

In the exemplary embodiment, each clamp member 140 and 142 also includes a pair of device mounting openings 210 defined therein. Alternatively, clamp member 140 and/or 142 may include more or less than two openings 210. In the exemplary embodiment, openings 210 are substantially centered between opposed clamp ends 142 and 144, and are spaced laterally apart within each clamp body 150. Alternatively, either clamp member 140 and/or 142 may include more or less than two openings 210. For example, in one embodiment, either clamp member 140 and/or 142 is formed without any openings 210. In the exemplary embodiment, openings 210 are identical and each is circular. Alternatively, openings 210 may have any cross-sectional shape. In the exemplary embodiment, openings 210 are spaced and oriented to enable a cleat 112 to be securely coupled to coupling system 102. Alternatively, openings 210 may be oriented and/or spaced in any pattern that enables any other mechanical device, such as a hook, to be coupled to the underlying structure 104.

Moreover, in the exemplary embodiment, each opening 210 extends from each clamp outer surface 192 to each clamp inner surface 190. In the exemplary embodiment, each opening 210 is recessed within the radial inner surface 190 of each clamp member 140 and 142. Accordingly, when a mounting fastener 220 is fully inserted through a respective opening 210 to secure a mechanical device, such as a cleat 112, to the coupling system 102, a radially inner end (not shown) of the mounting fastener 220 and the associated fastening mechanism (not shown), i.e., a nut, for example, does not extend outwardly beyond the edge 222 defining the each opening 210 within clamp inner surface 190. Moreover, the recessed area of each opening 210 ensures that neither the mounting fastener 220 nor the associated fastening mechanism, contact the underlying structure 104 to which the clamping system 102 is coupled. As a result, the mounting fastener 220 does not penetrate the underlying structure 104 and damage to the structure 104 from the coupling system 102 is facilitated to be substantially eliminated.

In the exemplary embodiment, each clamp member 140 and 142 includes a substantially planar mounting block (not shown) formed integrally therewith. More specifically, each mounting block, in the exemplary embodiment, is substantially planar and has a shape that is substantially similar to a shape of the base 240 of the mechanical device 112 to be secured thereto. Alternatively, either clamp member 140 and/or 142 can be formed with more than one mounting block. Moreover, each clamp member 140 can be formed without any mounting blocks. Forming the mounting blocks substantially planar and with substantially the same shape as the mechanical device base 240, facilitates enhancing seating between the mechanical device 112 and the coupling system 102 such that vibrations, wobbling, and/or wear between the mechanical device 112 and the clamp outer surface 192 are facilitated to be substantially minimized. In alternative embodiments, at least one mounting block may be fabricated non-planar to facilitate accommodating a desired mechanical device and/or to facilitate providing additional space to prevent the mechanical device from interfering with other structures, such as a sail for example. In yet another alternative embodiment, at least one mounting block may be recessed. In a further alternative embodiment, at least one clamp member 140 and/or 142 may be formed with a clip or another attachment point rather than a mounting block.

Although the present invention is described and illustrated herein with at least one mounting block that includes attachment openings formed therein, in other embodiments at least one mounting block may be formed with any other type of attachment mechanism including, but not limited to, threaded openings, a tongue and groove configuration, a slide-interference fit, and/or a slot, for example.

In the exemplary embodiment, to facilitate reducing wear, while enhancing the gripping between the clamping system 102 and the underlying structure 104, the clamping system 102 includes a membrane 270. In the exemplary embodiment, the membrane 270 is formed with openings (not shown) defined therein that are substantially concentrically aligned with the openings 210 when the membrane 270 is installed or positioned relative to each clamp member 140 and 142. In one embodiment, the membrane 270 could include an adhesive backing and/or could include openings formed therein that are substantially concentrically aligned with openings 210 to facilitate access to fasteners 220, for example.

In one embodiment, the membrane 270 is fabricated from, but is not limited to being fabricated from, a rubber material. More specifically, in the exemplary embodiment, each clamp member inner surface 190 includes a recessed area 300 that is offset a distance dₘ from the other portions of the inner surface 190. The offset distance dₘ is approximately the same distance as a thickness (not shown) of the membrane 270. The thickness of the membrane 270 may be variably selected depending on a desired clearance, for example. Accordingly, the recessed area 300 is sized to receive the membrane 270 therein such that a radially outer surface 302 of the membrane 270 is secured tightly against each clamp member inner surface 190, and such that a radially inner surface 304 of the membrane 270 is substantially co-planar with the non-recessed areas 310 of the clamp member inner surface 190 surrounding the recessed area 300. In addition to enhancing gripping between the coupling system 102 and the underlying structure 104, the membrane 270 also facilitates creating a waterproof seal between the clamping system 102 and the underlying structure 104 such that corrosion, for example, is facilitated to be reduced. Furthermore, the recessed area 300 facilitates preventing the membrane 270 from inadvertently shifting position during assembly of the coupling system 102. Moreover, in at least some embodiments, the membrane 270 facilitates damping vibrations that may otherwise be induced through the clamping system 102 from the mechanical device 112.

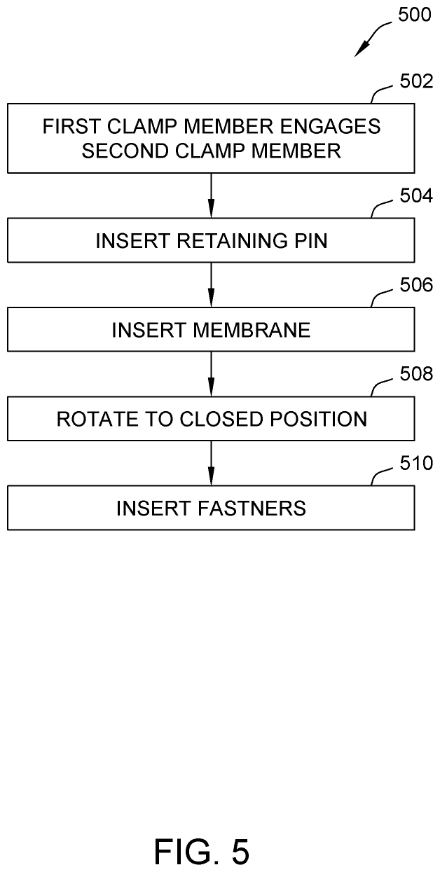

FIG. 5 is a flow chart 500 of an exemplary method of attaching a coupling system, such as coupling system 102, to a circular structure, such as mast 104. In the exemplary embodiment, initially a first clamp member 140 engages 502 a second clamp member 142 along the clamp member first ends 144. More specifically, after the clamp members 140 and 142 are engaged 502, the clamp member hinge members 160 are interlocked and a retaining pin can be inserted 504 through the hinge member openings 162 to securely couple the clamp members 140 and 142 together such that at least one member 140 and/or 142 is rotatably coupled to the other clamp member 142 and/or 140.

The interlocked clamp members 140 and 142 are then rotated to an open position 172 and a membrane 270 is inserted 510 into the recessed area 300 defined along the radially inner surface of each clamp member 140 and 142. The coupling system 102 is positioned adjacent to the structure 104 and the clamp members 140 and 142 are rotated towards the closed position 170 and about the structure 104. As the clamp members 140 and 142 are rotated to the closed position, the membrane 270 contacts the outer surface 152 of the structure, and the clamp member mating surfaces 180 are brought into contact with each other, such that surfaces 180 are substantially flush with each other.

A plurality of fasteners 202 are inserted through the fastener openings 200 and are tightened such that the coupling system 102 circumscribes the structure 104 and is securely held in position with the membrane 270 tightly against the outer surface 152 of the structure 104. In one embodiment, at least one mounting fastener 220 is inserted through openings defined in the mechanical device 112 and are secured within the openings 210. In one embodiment, the coupling system fastener openings 210 are threaded. Alternatively, as described herein, the coupling system 102 may include any other type or configuration of attachment point other than openings 210. In another embodiment, a fastening mechanism, such as a nut, is secured, such as with an adhesive, or a weld, for example, within the recessed area of each opening 210 prior to the coupling system being secured to the structure 104.

In some embodiments, the hinge member openings 162 are sized to receive a retaining pin formed from readily available stock material from standard suppliers. For example, the openings 162 may be sized to accommodate standard pin diameters such as, but not limited to, ⅛ inch, 3/16 inch, ¼ inch, 5/16 inch, ⅜ inch, or metric equivalents thereof. Sizing the openings 162 to receive standard stock pin material facilitates ease of replacement and may reduce manufacturing costs associated with the coupling system 102.

In some embodiments, the device mounting openings 210 are configured as through-holes extending from the outer surface 192 to the inner surface 190, and each may include a chamfered or countersunk recess formed on the inner surface 190. The chamfered recess may be sized to receive a tapered head fastener, such as a flat head screw or countersunk bolt. In such embodiments, the mounting fasteners 220 may be inserted from inside the clamp half, i.e., from the inner surface 190 extending towards the outer surface 192, such that the tapered head of the fastener may be seated within the chamfered recess. Accordingly, the tapered fastener head may be recessed within the inner surface 190 such that the fastener head does not contact or damage the underlying structure 104 when the coupling system 102 is secured thereto.

In some embodiments, each clamp member 140, 142 includes at least one relief cut formed in the clamp body 150. The relief cut may be positioned adjacent to the fastener openings 200 and/or to the device mounting openings 210. The relief cut provides clearance for insertion of fastening tools, such as screwdrivers, wrenches, or socket drivers, and facilitates bolt insertion during assembly of the coupling system 102. In some cases, the relief cut may be formed as a notch, slot, or recessed channel extending into the clamp body 150.

In some embodiments, the recessed areas for receiving fastening mechanisms, such as nuts, are dimensioned to facilitate improved nut insertion while providing enhanced retention. More specifically, the nut-receiving recesses or slots may be sized slightly larger than the nut profile to permit easy insertion of the nut during assembly, while maintaining sufficient engagement between the nut and the recess walls to prevent the nut from rotating or dislodging during tightening of the associated fastener.

In some embodiments, each clamp member 140, 142 includes one or more nut retention flats formed within the recessed areas adjacent to the fastener openings 200 and/or the device mounting openings 210. The nut retention flats are configured to engage corresponding flat surfaces on a nut, such as the flat sides of a hex nut, to prevent rotation of the nut during tightening of the associated fastener. The nut retention flats thereby facilitate single-tool assembly, as a user may tighten the fastener without requiring a second tool to hold the nut stationary.

In some embodiments, at least one clamp member 140, 142 includes an engraved logo, trademark, or other identifying indicia formed on the outer surface 192 thereof. The logo or indicia may be formed by engraving, embossing, debossing, laser etching, or molding integrally with the clamp member during manufacture. In some cases, the logo or indicia may be positioned on the mounting block or on another visible portion of the clamp outer surface 192.

In some embodiments, the clamp body 150 is formed with a reduced radial thickness compared to other embodiments described herein. The reduced thickness may decrease material usage and overall weight of the coupling system 102 while maintaining structural integrity sufficient to securely couple the mechanical device 112 to the structure 104 without damaging the structure 104. In some cases, the reduced thickness clamp body 150 may be fabricated from a high-strength material, such as carbon fiber, fiberglass, or a reinforced polymer, to compensate for the reduced material volume.

In an alternative embodiment, the cleat 112 or other mechanical device is integrally formed with at least one clamp member 140, 142. More specifically, in some embodiments, the cleat 112 is fabricated as a unitary component with the clamp member 140 and/or 142 using additive manufacturing, commonly referred to as 3D printing. The integrally formed or printed cleat eliminates the need for separate mounting fasteners 220 to couple the mechanical device to the clamp member, thereby reducing part count and simplifying assembly. The integrally formed clamp member and cleat may be fabricated from polymer materials, composite materials, metal materials, or any other material suitable for additive manufacturing processes. In other embodiments, the cleat 112 may be integrally formed with the clamp member 140 and/or 142 using injection molding, casting, or machining from a single workpiece.

Exemplary technical effects of the coupling system described herein include, for example: (a) coupling a mechanical device to a structure without damaging the underlying structure; (b) removably coupling a mechanical device to a structure without penetrating the underlying structure with a fastener mechanism; (c) providing a coupling system that is essentially “murphy-proofed” in that the clamp members are substantially identical; and (d) providing a coupling system that can be sized and shaped to engage any underlying structure.

Exemplary embodiments of a coupling system and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and/or applications, and is not limited to practice with the systems and related methods as described herein. Rather, the exemplary embodiment can be implemented and utilized in connection with many applications where coupling a mechanical device to a structure is desired.

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A coupling system for use with a structure, the coupling system comprising:
a first clamp member comprising a first end, a second end, and a body extending therebetween, the first end formed with a coupling mechanism, the second end formed with at least one fastener opening extending therethrough;
a second clamp member comprising a first end, a second end, and a body extending therebetween, the first end formed with a coupling mechanism, the second end formed with at least one fastener opening therethrough, wherein the second clamp member first end is configured to engage the first clamp member first end to rotatably couple the first clamp member with the second clamp member, wherein the second clamp member second end is configured to couple to the first clamp member second end such that the coupling member can be securely coupled to the structure without damaging the structure, and such that coupling system tightly circumscribes the structure.

2. The coupling system in accordance with claim 1, wherein each of the first clamp member and the second clamp member include a radially inner surface and an opposite radially outer surface, wherein the radially inner surface is shaped to tightly conform to an outer surface of the structure.

3. The coupling system in accordance with claim 2, wherein the first end of the first and second clamping members are configured to interlock with each other to securely couple the first clamping member to the second clamping member.

4. The coupling system in accordance with claim 3 wherein the first end of the first and second clamping members are formed with annular hinges.

5. The coupling system in accordance with claim 3 wherein the second end of the first and second clamping members are each formed with a mating surface that includes at least one opening extending therethrough.

6. The coupling system in accordance with claim 5 wherein the second ends of the first and second clamping members are sized and oriented to mate substantially flush against each other when the coupling system is secured to the structure.

7. The coupling system in accordance with claim 5 wherein the first and second clamping member mating surface openings are configured to concentrically align with respect to each other when the coupling system is secured to the structure.

8. The coupling system in accordance with claim 3 wherein at least one of the first clamping member and the second clamping member includes at least one flat formed on the radially outer surface of the clamping member, the flat sized and oriented to engage at least one mechanical device to be secured to the structure.

9. The coupling system in accordance with claim 8 wherein the at least one flat includes at least one opening extending substantially radially therethrough, the opening sized to receive a fastener at least partially therein to facilitate securely coupling the mechanical device to the structure without damaging the structure, wherein the opening includes a chamfered recess formed on a radially inner side of the opening, the chamfered recess sized to receive a tapered head of the fastener such that the tapered head is recessed within the radially inner surface.

10. The coupling system in accordance with claim 3 wherein at least a portion of the radially inner surface of at least one of the first clamping member and the second clamping member is recessed with respect to remaining portions of the radially inner surface.

11. The coupling system in accordance with claim 10 further comprising a membrane sized and shaped to be received within the recessed area of the radially inner surface of at least one of the first clamping member and the second clamping member.

12. A clamping system for coupling a mechanical device to a structure, the clamping system including a pair of substantially identical clamping members that each include a first end that includes at least one hinge member, and a second end that includes at least one fastener opening extending therethrough, wherein the clamping members each include an inner surface that is shaped to substantially mirror an exterior surface of the structure, and a radially opposite outer surface that extends generally continuously from the first end to the second end, wherein at least one of the clamping members includes a flat formed on an outer surface of that clamping member, the flat being sized and shaped to enable the mechanical device to couple to the clamping system without damaging the structure.

13. The clamping system in accordance with claim 12 wherein the mechanical device is a cleat that is securely coupled to the coupling system.

14. The clamping system in accordance with claim 13 wherein the structure is a mast and each of the clamping member inner surfaces is arcuate and is formed with a radius of curvature that substantially matches the radius of curvature of the mast.

15. The clamping system in accordance with claim 14 the at least one of the clamping members includes one or more nut retention flats formed within a recessed area adjacent to the at least one fastener opening, the nut retention flats configured to engage corresponding flat surfaces on a nut to prevent rotation of the nut during tightening of an associated fastener.

16. The clamping system in accordance with claim 14 wherein at least one of the clamping members includes at least one relief cut formed in a body of the clamping member, the relief cut positioned to provide clearance for insertion of a fastening tool during assembly of the clamping system.

17. The clamping system in accordance with claim 16 wherein mechanical device is integrally formed with at least one of the clamping members.

18. A method of securing a mechanical device to a structure without damaging the structure, the method including:
providing a clamp system including a pair of clamp members that are substantially identical;
engaging a first end of a first of the clamp members with a first end of the second of the clamp members, such that the first ends of each of the clamp members are interlocked;
rotating at least one of the first clamp member and the second clamp member to an open position;
positioning the clamp system near the structure and rotating the clamp members to a closed position;
inserting at least one fastener through a portion of the first and second clamp members to securely couple the first clamp member to the second clamp member, and to securely couple the clamp assembly about the structure, such that an inner surface of the clamp members tightly circumscribes an outer surface of the structure; and
coupling the mechanical device to the coupling system and to the structure without damaging the structure.

19. The method in accordance with claim 18 wherein engaging the first end of the first clamp member with the first end of the second clamp member includes inserting a retaining pin through hinge member openings, wherein the hinge member openings are sized to receive a retaining pin having a standard stock diameter.

20. The method in accordance with claim 18 further comprising tightening the at least one fastener using a single tool, wherein at least one of the clamp members includes a nut retention flat configured to prevent rotation of a nut during tightening of the fastener.
